(19) United States
(12) Patent Application Publication
(10) Pub. No.: US 2009/0092251 A1
(43) Pub. Date: Apr. 9, 2009

(54) SYMMETRIC KEY CRYPTOGRAPHIC METHOD AND APPARATUS FOR INFORMATION ENCRYPTION AND DECRYPTION

(76) Inventor: Pal Bela Domosi, Debrecen (HU)

Correspondence Address: Hershkovitz & Associates, LLC, 2845 Duke Street, Alexandria, VA, 22314, US

(21) Appl. No.: 12/293,263

(22) PCT Filed: Feb. 20, 2007
(86) PCT No.: PCT/HU2007/000008

§ 371 Date: Sep. 16, 2008

(30) Foreign Application Priority Data
Mar. 17, 2006 (HU) P0600208

(51) Int. Cl. H04L 9/00; H04L 9/06

(52) U.S. Cl. 380/255; 380/277

(57) ABSTRACT

For information encryption and decryption the apparatus uses the same hardware keys, which have the transition matrix of a key-automaton with no output signal and with an initial state and a final state burnt in. To each character in the character set of the plaintext message there is one or more final states of the key-automaton assigned. During encryption the message is read in sequentially character by character and the key automaton assigns to each character a random character string, whose length is adjustable length within a given length range. The process is the following: for each character in the message the apparatus generates a character string of adjustable length and with no initial- and end markers, which takes the apparatus from its current state into the final state that corresponds to the subsequent character of the message. The apparatus creates the encrypted message by linking these character strings together. The encrypted message can be decrypted using the same apparatus.

### PRIOR ART

The aim of a coding device is to make message transfer from a sender to one or more recipients secure, so that only the intended recipients can decrypt the message. A coding device converts the original message into an encrypted message. Encryption means the manipulation or transformation of the message with the help of encryption key or keys. The recipient decrypts the message by reversing the manipulation or transformation process, that is, the encrypted message is converted, with the help of a secret decryption key or keys, into the original message. Since the secret keys are known only to the sender and the recipient, the message transfer is secure. A cryptographic device will mean a device which can, given the encryption unit and the encryption key, convert the message into an encrypted message and conversely, given the decryption unit and the decryption key, can convert the encrypted message into the original one. Among cryptographic devices we distinguish between: symmetric key cryptographic devices and public key (or asymmetric) cryptographic devices, which may use a variety of algorithms, that is, they use both symmetric and asymmetric encryption. There is a huge number of such devices starting with Enigma, developed between the two world wars, then various decoders, access points and hardware keys equipped with the smallest microcontrollers as well as smart cards. They are used in message encryption, in proving the integrity of a message, genuineness confirmation, in realising secure network communication, in data protection, in limiting broadcast pickup, in electronic bank transfers and in shopping etc. The baud rate is very important in many applications as well as security. For example coding and decoding in digital television broadcasting, internet encryption, or encryption of network communication. All these are applications, where the large number of people interested (in the case of television broadcasting this number may reach or even increase a hundred million) enhances the danger of hacking efforts. Furthermore, many hackers publish the broken code on the internet, so it spreads fast. This unfortunate fact causes the most important and still unsolved problem for broadcasting companies of these days. Similar devices used earlier and today (e.g. Rainbow iKey 2032 USB-key, Avaya Wireless PC card, USRobotics Wireless Turbo Access Point & Router), if they were symmetric key (e.g. DES, TripleDES keys), proved to be easy to hack, if they were asymmetric key (e.g. RSA, ElGamal keys) have a long encoding and decoding time, which is a drawback in real-time applications.

The cryptographic apparatus described in the present patent is symmetric key, where the incoming encrypted message is decrypted using the encrypting and decrypting apparatus and the encryption and decryption keys, and encrypts the plaintext message using the encrypting and decrypting apparatus and the encryption and decryption keys. The technical novelty of the apparatus in the patent, when compared with the devices above, is that if there is the transition matrix of a suitable finite automaton without outputs as a key automaton burnt into the apparatus, and encryption and decryption is performed in the described way, then micro-sized technical realization is relatively easy (microcontrollers, smart cards etc.) and, in spite of the use of symmetric key, security is immensely increased without any effects on the speed.

The theory of (abstract) automata, which was initially conceived to model computers and other discrete physical devices, has become an intensely researched field. According to the assumptions of the theory an (abstract) automaton functioning in a discrete time scale has, at every point in time, a well-defined (inner) state, while it receives input signals from outside. The automaton reacts an output signal for each input signal, and this output signal is uniquely determined by its current inner state and the received input signal, and then the input signal takes the automaton into a new state, which is also determined by its current state and the input signal, and this new state will be its current state at the next point in time. A special case of this (abstract) automaton type—which is often called Mealy machine—is the automaton without outputs, where either the current state of the automaton is considered to be the output signal or there is supposed to be no output signal at all. An introduction to the theory of automata recommended is ‘Automata Theory’ by M. Simon (World Scientific Press, Singapore, 1999) or ‘Introduction to Automata Theory’ by J. E. Hopcroft, R. Motwani and J. D. Ullman (second edition, Addison-Wesley Series in Computer Science, Addison-Wesley Co., Reading, Mass., 2001). Due to development in automata theory, research in cellular automata started about 30 years ago and has been intensive ever since and it has an important role in modelling discrete physical systems of multiple components. The components of a cellular automaton are atomic automata with no output signal, called cells, whose input signals are the (inner) states of their neighbouring cells, where the neighbourhood of a cell is determined by a neighbourhood topology. A survey of cellular automata is provided by e.g. M. Garzon: ‘Models of Massive Parallelism. Analysis of Cellular automata and Neural Networks’ (Texts in Theoretical Computer Science. An EATCS Series. Springer-Verlag, Berlin, 1995).

Automata theory provides a natural basis for designing cryptosystems and several such systems have been designed. Some of them are based on Mealy automata or their generalisation, while others are based on cellular automata.

Almost all cryptosystems can be modelled with Mealy machines (as sequential machines) or generalised sequential machines. During encryption the system first receives a preliminary input, which contains the encryption key automaton (and sometimes a secondary encryption key as well). Following this key the input contains the plaintext stream, as a string of input signals for the automaton, and starting the automaton from a given state, the encrypted message can indeed be generated as an output signal string initiated by the input signal string. Decryption is performed in a likewise manner: the decryption key is substituted by the encryption key so that plaintext and ciphertext messages change roles. This method has several variants.

Rayward-Smith systems [V. J. Rayward-Smith: Mealy machines as coding devices. In: H. J. Beker and F. C. Piper, eds., Cryptography and Coding, Claredon Press, Oxford, 1989.] use ordinary Mealy machines. Gysin systems [M. Gysin: One-key cryptosystem based on a finite non-linear automaton. In: E. Dawson and J. Golic, eds., Proc. Int. Conf. Proceedings of the Cryptography: Policy and Algorithms, CPAC'95, Brisbane, Queensland, Australia, Jul. 3-5, 1995. Lecture Notes in Computer Science 1029 Springer-Verlag, Berlin, 1995, 165-163.] use special Mealy encryption and decryption automata, where encryption and decryption are realised in several repeated simple steps, called turns. Similarly to Rayward-Smith systems and Gysin systems, Tao systems [R. Tao: On finite automaton one-key cryptosystems. In: R. Anderson, ed., Proc. 1^{st} Fast Software Encryption Workshop—FSE'93. Proceedings of the Security Workshop held in Cambridge, Cambridge, UK, Dec. 9-11, 1993, LNCS 809, Springer-Verlag, Berlin, 1994, 135-148.] are based on sequential Maely machines.

The vulnerability of these systems is due to the well-known fact that automaton mappings are length and prefix preserving. Knowing a great number of encrypted messages the system can be attacked by brute force search. Based on this fact Wichmann developed a system of cryptoanalysis [P. Wichmann: Cryptoanalysis of a modified rotor machine. In: J.-J. Quisquarter, J. Vandewalle, eds., Proc. Conf. Advances in Cryptology—EUROCRYPT'89, Workshop on the Theory and Applications of Cryptographic Techniques, Houthalen, Belgium, Apr. 10-13, 1989, LNCS 434, Springer-Verlag, Berlin, 1990, 395-402.].

Atanasiu systems [A. Atanasiu: A class of coders based on gsm. In. Acta Informatica, 29 (1992), 779-791.] are similar to Rayward-Schmith systems, with the considerable difference, that they use generalised sequential machines. It is also well-known, though, that mappings induced by generalised sequential machines are prefix preserving. Thus Atanasiu systems have the same security problems as systems based on Mealy machines.

Tao-Chen public key FAPKC systems [R. Tao and S. Chen: Finite automata public key cryptosystem and digital signature. In: Computer Acta 8 (1985), 401-409 (in Chinese).] use the mathematical conjecture that for delayed, weakly invertible automata it is difficult to find the reverse automaton. Unfortunately these systems can also be defeated [F. Bao and Y. Igarashi: Break finite automata public key cryptosystems. In: Zoltán Fülöp, Ferenc Gécseg, eds., Proc. 22^{nd} Int. Coll. on Automata Languages and Programming—ICALP'95, Szeged, Hungary, Jul. 10-14, 1995, LNC 944, Springer-Verlag, Berlin, 1995, 147-158.] So as to prevent attacks there was a refinement of this system developed, called FAPKC-3 [R. Tao, S. Chen and X. Chen: FAPKC3: a new finite automata public key cryptosystem. Publ.: Technical report No. ISCAS-LCS-95-05, Laboratory for Computer Science, Institute of Chinese Academy of Sciences, Beijing, 1995.]. Meskaten discusses two methods to break this cryptographic system [T. Meskaten: On finite automaton public key cryptosystems. Publ.: TUCS Technical Report No. 408, Turku Centre for Computer Science, Turku, 2001, 1-42.].

All the well-known cryptosystems based on Mealy machines have proved to be vulnerable, which is a serious drawback in applications.

Almost from the very beginning of researches of cellular automata, there have been serious attempts at cryptographic applications. Cryptosystems of this kind usually use the plaintext as the initial state of the cellular automaton, the encryption key being the transition rules for the cells. The state reached after a given number of steps provides the encrypted message. Decryption is performed in a similar manner, starting from the encrypted message as a state, the initial state is determined which is then the decrypted message.

The Wolfram system [S. Wolfram: Cryptography with Cellular Automata. In: C. W. Hugh, ed., Proc. Conf. Advances in Cryptology—CRYPTO'85, Santa Barbara, Calif., USA, Aug. 18-22, 1985, LNCS 218, Springer-Verlag, Berlin, 1986, 429-432.] use one dimensional cellular automata, which produce a random bit string. This bit string is added to the plaintext stream bit by bit. Meier and Staffelbach [W. Meier and O. Staffelbach: Analysis of pseudo-random sequences generated by cellular automata. In: D. W. Davies, ed., Proc. Conf. Advances in Cryptology—EUROCRYPT'91, Workshop on the Theory and Application of Cryptographic Techniques, Brighton, UK, Apr. 8-11, 1991, LNCS 547 Springer-Verlag, Berlin, 1991, 186-199.] gave a cryptoanalysis of Wolfram system. Furthermore, although extensive statistical tests have been conducted to analyse pseudo-random numbers [S. Wolfram: Random sequence generation by cellular automata. In: Adv. Applied Math. 7 (1986), 123-169.], there is no mathematical proof available. The same applies to the system patented by Bianco and Red [U.S. Pat. No. 5,048,086], as it is known [H. B. Lin: Elementary Symbolic Dynamics and Chaos in Dissipative Systems. Publ.: World Scientific, Singapore, 1989.], that is the generated pseudo-random bit stream will not be random for most choices of parameter. Habutsu at al. [T. Habutsu, Y. Nishio, I. Sasase, S. Mori: A Secret Key Cryptosystem by Iterating a Chaotic Map. In: D. W. Davies, ed., Proc. Conf. Advances in Cryptology—EUROCRYPT'91, Workshop on the Theory and Application of Cryptographic Techniques, Brighton, UK, Apr. 8-11, 1991, LNCS 547 Springer-Verlag, Berlin, 1991, 127-140 .] recommend a cryptosystem based on the iteration of chaotic maps. Two methods, described by Biham [E. Biham: Cryptoanalysis of the chaotic map cryptosystem suggested at EUROCRYPT'91. In: D. W. Davies, ed., Proc. Conf. Advances in Cryptology—EUROCRYPT'91, Workshop on the Theory and Application of Cryptographic Techniques, Brighton, UK, Apr. 8-11, 1991, LNCS 547 Springer-Verlag, Berlin, 1991, 532-534.] can be used to defeat these systems. Recently, further efforts have been taken by Sen at al. [S. Sen, C. Shaw, D. R. Chowdhuri, N. Ganguly, P. P. Chaudhuri: Cellular automata based cryptosystem (CAC). In: R. Deng, S. Qing, F. Bao, J. Zhou eds., Proc. 4^{th} Int. Conf. on Information and Data Security—ICIS 2002, Dec. 9-12, 2002, Singapore LNCS 2513, Springer-Verlag, 2002, 303-314.] to create cellular cryptosystems (CACs) based on cellular automata, where affine cellular automata are combined with non affine transformations. Bao showed F. Bao: Cryptoanalysis of partially known cellular automata. In: a) R. Safavi-Naini, J. Seberry, eds., Proc. 8^{th} Australian Conf. on Inf. Security and Privacy—ACISP'03, Wollongong, Australia, Jul. 9-11, 2003, LNCS 2727, Springer-Verlag, Berlin 2003, 416-427, b) IEEE Trans. on Computers, 53 (2004), 1493-1497.] that these systems are not secure either. Bao also stated [F. Bao: Cryptoanalysis of partially known cellular automata. In: IEEE Trans. on Computers, 53 (2004), 1493-1497.] that minor changes are not enough to make this system secure.

There are other cellular automaton based public key cryptosystems that are secure, but they are not practical. Guan's public key cryptosystem [P. Guan: Cellular automaton public key cryptosystem. In: Complex Systems, 1 (1987), 51-56.] is secure, but it requires a very careful choice of the cellular automata used. Guan's method involves solving systems of polynomial equations during encryption, hence its practical realization leads to slow performance. The strong security of Kari's public key cryptosystem [J. Kari: Cryptosystems based on reversible cellular automata. Publ: University of Turku, Finland, April, 1992, preprint.] is based on the well-known result that for cellular automata of at least two dimensions, the question whether they have an inverse or not cannot be answered [J. Kari: Reversibility of 2D Cellular Automata is Undecidable. In: Physica D, Vol 45 (1990), 379-385.]. This fundamental result highlights a considerable problem. It is very difficult or if not impossible to build a reverse automaton for a given cellular automaton. This fact sets considerably limits for the applicability of reversible cellular automata in cryptography.

These difficulties are overcome by Gutowitz's cellular automaton based, symmetric encoding system [Gutowitz, U.S. Pat. No. 5,365,589]. More precisely, Gutowitz systems are highly secure in spite of their use of a random number generator. This high level of security is partly due to the fact that unlike other cellular automata systems using random number generator, the random number generator in Gutowitz systems can be entirely independent from the structure of the key-automaton used. At the same time—unlike Guan systems—the simplicity of its components makes Gutowitz systems fast. Finally, when compared to Kari systems, it is easy to generate the suitable key-automata for Gutowitz systems. Besides all this, like most cellular automaton based cryptosystems Gutowitz systems are essentially coded block ciphers, where encoding is performed with a string of cellular automata. This is why—no matter whether the functioning control of the automaton string is sequential or parallel—serious technical difficulties are faced in micro-sized technical realization of Gutowitz systems. Apart from the technical difficulties, using Gutowitz systems is not economical in situations when the specific nature of the process requires bit-by-bit or character-by-character encoding/decoding. This is so, because Gutowitz systems are of coded block ciphers.

The best-known cellular automaton based cryptosystems all share the common problem of serious realization difficulties: some systems are easy to defeat, the technical realization of others result in slow performance, and still others exhibit difficulties in the choice of the key-automaton. A further common drawback of cellular automaton based cryptosystems is (just like Gutowitz systems) that their micro-sized technical realization poses serious difficulties and they are not always economical either.

The subject matter of the present invention is a cryptographic apparatus with a Rabin-Scott automaton as key for encoding and decoding information. Unlike the above described cryptosystems the key is neither a Mealy machine nor a cellular automaton.

The present invention is similar to Mealy machine based cryptosystems in that encoding and decoding is performed using a key automaton. Unlike Mealy machine based or generalised sequential machine based cryptosystems, whether certain mappings preserve length and prefix or other mappings preserve prefix or not has no significance here, so these properties cannot be exploited for hacking. The properties of weakly reversible automata do not affect the invention either, so this invention cannot be hacked with methods used for defeating FAPKC and FAPKC-3 cryptosystems either.

The present invention is similar to cellular based cryptosystems in that the key-automaton is an automaton without outputs, like the cells in a cellular automaton. Furthermore, the encoded message here is created in a somewhat similar manner (via manipulations on states) to the functioning of cellular automata, i.e. using the changes in the state of the key automaton. This present invention is particularly similar to Gutowitz cellular based cryptosystem, in the sense that there is also a random number generator, which is independent from the key. Apart from having all the advantages of Gutowitz systems, the present invention does not pose any serious difficulties for micro-sized technological realization.

The present invention does not share the problems the abovementioned cryptosystems have. Although the invention uses a random number generator, it can take random number generators which are proved to be random indeed, or it can use any radioactive or other physical random number sources. Therefore, the recipient of the message does not need to know how this randomness is realised in the specific message which is generated during the encryption of the original dataflow. The plaintext message consists of such fixed length blocks (with no initial or end marker), where each block represents a character (of one byte or half a byte or quarter of a byte or one bit length). To each plaintext message there are several (in theory, there are infinitely many) corresponding encoded messages. Ciphertext messages constitute of blocks (with no initial or end marker) of varying length, where each block stands for a character string. (The plaintext message and the encoded message have the same number of blocks.) Since there are no initial or end markers in the encoded message, the blocks cannot be identified without the key-automaton. So, without the key automaton, even the length of the message is difficult to estimate, since block lengths and the number of blocks are not public for hackers. Due to the large number of possible key-automata, brute force attacks do not lead to success either.

Thus incorporating the advantages of known cryptosystems the invention makes hacking impossible without knowing the key, and as it also has a simple structure encoding and decoding is fast. Also due to its simple structure its micro-technological realization (microcontrollers, smart cards, etc.) is not difficult.

### SUMMARY OF THE INVENTION

The essence of the invented apparatus is
to each element of the character set of the plaintext there is one or more final states of the key automaton assigned and each final state is assigned to one and only one element of the character set
for every state pair, whose first element is the initial state or a final state, its second element is any final state, there are arbitrarily many distinct input signal strings such that
the last element of state string, assigned to the first element of the state pair and the given input signal string by the generalised transition function, is the same as the second element of the state pair
and none of the intermediate elements of the state string is a final state.

The essence of the invented method is
in encryption mode the key automaton
reads in the plaintext character by character starting from the initial state
generates a randomly chosen character string of length falling into a given, adjustable length interval for each character in the plaintext
the ciphertext consists of these character strings linked together
in decryption mode the key automaton
reads in the ciphertext character by character starting from the initial state
and decryption is accomplished by linking together the plaintext characters associated with the occurring final states, which provides the message in its original form.
During decryption the key automaton
starting from the initial state reads in the ciphertext character by character
and decryption is accomplished by linking together the input signals associated with the occurring final states, which provides the message in its original form.

### DEFINITIONS

An initial automaton with an initial state and final states and no outputs (which is also referred to as Rabin-Scott automaton in the literature for short) is an algebraic structure which consists of two non-empty sets and a function, and where one element and a non-empty subset of one of the sets is distinguished. One of the two non-empty sets is called the state set and the other is the input set. The function which maps the product of the state set and the input set into the state set is usually called transition function. The elements of the state set are the states and the elements of the input set are the input signals. A transition function can thus also be given as the function that associates a state with each pair, whose first element is a state and its second element is an input signal. The distinguished element of the state set is the initial state; the distinguished subset is the set of final states. The elements of the set of final states are the final states. It may happen that the initial state is a final state as well (this is not excluded).

Initial automata with an initial state and final states and with no outputs will henceforth be called automata for short.

In our description we assume that the state set, the input set (as well as the set of final states) is finite. We shall also assume that both the state set and the input set are ordered sets, so we shall use the terms zeroth, first, second . . . and last elements. (For technical reasons counting starts with zero instead of one.) For finite state sets and input sets the transition functions are also represented as matrices, which are called transition matrices. The transition matrix has as many rows as the number of input signals and as many columns as the number of states the automaton has. An element k in the i-th (starting from zero) row and j-th (starting from zero) column of the transition matrix is the number (starting from zero) of the state which by the transition function associates with the pair of the j-th state and the i-th input signal. We say about the element k of the i-th row and j-th column of the transition matrix that the i-th input signal takes the automaton from the j-th state into the k-th state. (We also say that the automaton goes from its j-th state into its k-th state under the effect of the i-th input signal.)

A finite list of the elements of the state set is called a state string; a finite list of elements of the input set is called an input signal string. (Input signal strings and state strings of length one that is of one element are not excluded.) Strings of binary elements that is of 0 and 1 are also called bit strings. The commas between the elements either in state strings or in input signal strings will be omitted (as is customary). If a state string a₁a₂. . . aₛ has at least three elements, the states a₂ and a₃, . . . , and as aₛ₋₁ are also called intermediate states. A sequence of one or two elements has no intermediate states. The transition function of the automaton is extended in the usual way, so that to each state and input signal the extended transition function assigns a state string as follows:

Let a be a state and x₁x₂. . . xₛ be an input signal string (where x₁, and x₂, . . . , xₛ are input signals). Let a₁ be the state into which the input signal x₁ takes the automaton from state a, then a₂ be the state into which the automaton is taken by the input signal x₂, and then a₃ the state where the automaton is taken by the input signal x₃. . . , and aₛ be the state into which the automaton is taken from the state aₛ₋₁ by the input signal xₛ. Then the extended transition function assigns, by definition, the state string a₁a₂. . . aₛ to the pair consisting of state a and the input signal string x₁x₂. . . xₛ. Then we also say that the input signal string x₁x₂. . . xₛ takes the automaton from state a into state aₛ through the state sequence a₁a₂. . . aₛ.

Finally, if an automaton has the features discussed above in the summary of the invention, then it is a key-automaton. The key-automaton accomplishes encryption by generating a random character string with no initial or end marker for each character in the plaintext and then linking them together provides the ciphertext. We shall assume that these random character strings have a minimal block length, which is the minimal block length and a maximal length that is the maximal block length.

### DETAILED DESCRIPTION OF THE INVENTION

FIG. 1 shows an example cryptographic apparatus, whose input is linked to the data input (2) of the processing unit (3) through an input line driver (1). The data output (4) of the processing unit (3) is linked to the output of the cryptographic apparatus through an output line driver (5). A further input of the processing unit (3) has a two-way connection with the key automaton (7) and data memory (8) through data bus (6). 3 The processing unit has a direct two-way connection with program memory (9). A further input of the processing unit has a two-way connection with a random number source, preferably a random number generator (10).

If encoding and decoding is accomplished by two separate devices, an input of the processing unit in the encoding device needs to be in a two-way connection with a random number source, preferably a random number generator (10). A cryptographic device used solely for decoding does not need a random number generator (10).

The invented cryptographic apparatus is capable of encoding and decoding as well, and then decoding is accomplished in the opposite direction in the device. The input of the device reads in the plaintext when encoding and the ciphertext when decoding. The output is the ciphertext when encoding and the plaintext in its original form, when decoding, respectively.

One or more final states of the key-automaton (7) are assigned to each element in the character set of the plaintext, and each final state is assigned to only one element of the character set. To each state pair, where the first element is the initial or a final state, the second element is any final state, there can be found a great number of distinct input signal strings, so that the last element in the state sequence, assigned by the generalised transition function to the first element in the state pair and the input signal string, is the same as the second element in the state pair, while none of the other elements in the state string is a final state.

The key-automaton (7) in the invention is preferably realised by a Rabin-Scott key automaton, but other key automaton (7), like deterministic automaton, non-deterministic automaton, weighted automaton, cellular automaton, two-way automaton, automaton networks, linearly limited automaton, stack automaton, tree automaton, Turing machines, transducers, two or more taped automaton, two or more taped transducers, or some combination of these are also possible.

The blocks in the cryptographic device shown in the example are realised by the following products:

The key-automaton (7) is installed (burnt) in a 4 kilobyte flash memory integrated into ATMegal28; the program memory (9) is 128 kilobyte PROM module integrated into ATMegal28; the 8 data memory (8) is a 4 kilobyte MCU SRAM integrated into ATMegal28; the random number generator (10) is PROTEGO R300 and the line drivers (1,5) are RS232 with PC links.

The cryptographic device in the invention accomplishes encoding and decoding in the following way:

The device functions as an encoding device when in encoding mode and as a decoding device when in decoding mode. The transition matrix in the key-automaton (7) is realised as a continuous row array and the minimal and maximal block lengths of the encrypted message is burnt in the flash memory. Working data, while processing, is stored in the data memory (8). It also stores the current state of the key-automaton (current state), the state of the key-automaton currently to be reached (state to be reached) as well as a working array for storing character strings (where the character set, depending on the actual technical realisation, can be of two, four or eight bits), and whose length is also the maximal block length of the encrypted message, and a pointer, pointing to the element under processing in the working array. The program memory (9) has the program of the encrypting and decrypting algorithm burnt in, which is interpreted by the processing unit (3).

Steps of Encryption:
1. Providing space in the data memory (8) for the current state, the state to be reached, the work array and the pointer, and the current state takes the value zero.
2. The plaintext is fed into the processing unit (3) from the input line driver (1) in the form of a character stream.
3. The next character is read in (first character first).
4. The state to be reached in the data memory (8) will be of the same numeric value as that of the incoming character.
5. The pointer in the data memory (8) takes value zero.
6. The following steps are repeated as long as the current state and the state to be reached in the data memory become the same.
   If the value of the pointer is greater than the maximal block length of the encrypted message minus one, then quit the cycle and go to step 5.
   Generate a random character with the random number generator (10).
   The generated random character will be the element of the work array (enumeration starting with zero) to which the pointer points.
   The value of the pointer increases by one.
   The new current state of the transition matrix in the key-automaton will be that element, whose row number is (starting from zero) the numeric value of the generated random character, its column number (starting from zero) is the numeric value of the current state.
   If the numeric value of the new current state is the same as the numeric value of the character, but the new current state is different from the state to be reached, quit the cycle and go to step 5.
   Generate a random bit (zero or one) based on the random number generated by the random number generator (10).
   Check the validity of the following properties:
      The value of the generated random bit is one.
      The new current state and the state to be reached are different.
      The value of the pointer is at least the value of the minimal block length of the encrypted message minus one.
      The value of the pointer is at most the value of the maximal block length of the encrypted message minus one.
      There is a character that takes the key automaton from the current state into the state to be reached.
   If all the properties above hold, accomplish the following steps
      Generate a random character based on the random number generated by the random number generator (10) which takes the key-automaton (7) from its current state into the state to be reached.
      Write the generated random character such as the element of the work array to which the pointer points.
      The value of the pointer increases by one.
      The actual state becomes the state to be reached.
7. If the value of the pointer is less than then minimal block length of the encrypted message minus one go to step 5.
8. The processing unit (3) sends the content of the work array (sequentially), where the length is determined by the value of the pointer, as output data (4) to the output line driver (5), and then the pointer takes the value zero.
9. The current state in the data memory becomes the state to be reached after step 4.
10. If there are more input characters, then functioning continues from step 3. If there are no more input characters, encryption is finished.

Steps of Decryption:
1. Providing space in the data memory (8) for the current state, the state to be reached, the work array and the pointer, and the current state takes the value zero.
2. The encrypted message is fed into the processing unit (3) through the input line driver (1) as a character stream.
3. The next character is read in (first character first).
4. The value of the new current state in the data memory (8) will be the element of the transition matrix of the key-automaton (7) whose row number (starting from zero) is the numeric value of the character read in step 3, and its column number (starting from zero) is the numeric value of the current state.
5. If the numeric value of the current state is the same as the value of a character, then this character is written to the output line driver (5).
6. If there are more incoming characters, go to step 3. If there are no more incoming characters, decryption is finished.

During encryption the plaintext is read in character by character starting from the initial state of the key-automaton (7), and to each character, a random character string of adjustable length in a given length interval is assigned, and by linking these character strings together we get the encrypted message. These random character strings will take the key automaton from its current state into the final state assigned to the character read in, so that none of intermediate states are final states. Before reading in the first character the current state of the key automaton in the encryption device is the initial state, and then before reading in the next character it is the final state assigned to the previous character. During decryption the encrypted message is read in character by character starting from the initial state of the automaton, and by linking together the input signals assigned to the final states found we get the original message.

A Possible Realization for Binary Message Streams:

Micro-technological realization is easiest for binary message streams. The input and output characters of the device(s) are binary, in this case, and the random number generator (10) is also binary, that is, it is used for generating a single random bit only.

Other Possible Ways of Realization

The above described realization of the invention—including the version for binary message streams—assigns to each character the state of the key-automaton (7) which has the same numeric value as the numeric value of this character. There are other possible ways of realization—to increase security—when there can be more than one final states for each character. In such a realization the flash memory of the key-automaton (7) has to store (in the form of a linked list for example) which final states are assigned to which character. Encryption changes only in step 4. from the realization described above, so that the random number generator (10) or another random number source determines which of the possible final states associated with the character should be the current state to be reached. Decryption changes in step 5. only, so that whenever the current state is a final state, the character to which the current state corresponds as a final state is written to the output line driver (5).

### SHORT DESCRIPTION OF THE FIGURE

FIG. 1. The block diagram of the invention shows the structure of the two functional (encryption and decryption) device and the connections between its components.

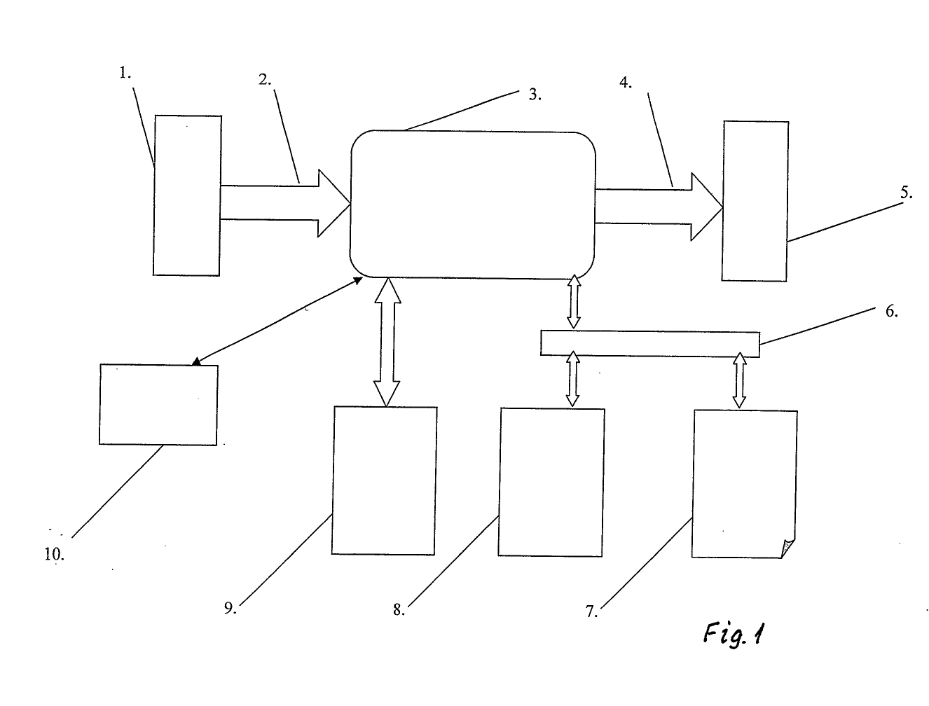

### EXAMPLE

Let the transition matrix of the key-automaton (where the initial state is 0) be the following:

| | | | | |
|---|---|---|---|---|
| 4 | 1 | 3 | 0 | 3 |
| 0 | 4 | 1 | 2 | 2 |

For simplicity suppose that the (binary) character set of the plaintext is {0,1}. Let us assign to the character 0 the final state 0, and to the character 1 the final state 1. Let L_{i,j} denote, for any pair i,j from {0,1,2,3,4}, the set of all input signal strings that take the automaton from its state i to state j, so that none of the intermediate states is a final state.

Encryption

Suppose that the device is in encryption mode, so the encryption program is stored in the program memory (9). There is space allocated in the data memory (8) to the current state of the key-automaton (current state), to the state to be reached by the key-automaton (state to be reached), to a work array, the size of which (in bits) is also the maximal block length of the encrypted message, and a pointer pointing to the element of the array under processing. Suppose that the size of the work array is 6 bits. In other words, suppose that the maximal block length of the encrypted message is 6 bits. Let the minimal block length of the encrypted message be 1 bit.

Let us consider the hexadecimal 4F4B ASCII code of the word OK. Converting this 4F4B code into binary code we get the string 0100111101001011. Suppose, that this is our plaintext. Also suppose that this is the message the invention will encrypt in encryption mode. The apparatus will show, on 5 the output line driver random signal strings of at least 1 and at most 6 bits length for each of the values 0,1,0,0,1,1,1,1,0,1,0,0,1,0,1,1 arriving sequentially into the input line driver (1), of the message 0100111101001011.

More precisely, when used as an encryption device, the reading in of the first bit from the input line driver (1) generates a random bit string (of at least 1 at most 6 bits length) and writes it on 5 the output line driver, which takes the key automaton from its initial state (i.e. state 0) to the final state (i.e. 0) assigned to the value of that first bit (i.e. 0) so that none of the intermediate states is a final state (i.e. neither 0, nor 1). More precisely, the device when receiving the signal 0 from the input line driver (1), it will write a random element (of at least 1 and at most 6 bits length) of L_{0,0} to the output line driver (5).

Then the current state will be the previous state to be reached (i.e. state 0) and the next bit read in from 1 the input line driver will cause the generation of a random bit string (of at least 1 and at most 6 bits length) and writes it on the output line driver (5), which takes the key automaton from its current state (i.e. state 0) to the final state (i.e. 1) assigned to the value of the bit read in (i.e. 1) so that none of the intermediate states is a final state (i.e. either 1 or 0). More precisely, the device triggered by the signal 1 coming from the input line driver (1) will write a random element (of length at least 1 and at most 6 bits) of L_{0,1} to the output line driver (5).

The device works similarly for the third, fourth, . . . , sixteenth bit read in, when after having a random element (of length at least 1 and at most 6 bits) of L_{0,0} and of L_{0,1} from the input line driver (1)) it will generate a random element (of length at least 1 and at most 6 bits) of the sets L_{1,0}, L_{0,0}, L_{0,1}, L_{1,1}, L_{1,1}, L_{1,1}, L_{1,0}, L_{0,1}, L_{1,0}, L_{0,0}, L_{0,1}, L_{1,0}, L_{0,1}, L_{1,1}.

Suppose, for instance, that these random bit strings (of length at least 1 and at most 6 bits) are the following:

| | |
|---|---|
| 1 | (is in L_{0, 0}) |
| 0011 | (is in L_{0, 1}) |
| 100 | (is in L_{1, 0}) |
| 1 | (is in L_{0, 0}) |
| 011 | (is in L_{0, 1}) |
| 0 | (is in L_{1, 1}) |
| 0 | (is in L_{1, 1}) |
| 1011 | (is in L_{1, 1}) |
| 100 | (is in L_{1, 0}) |
| 011 | (is in L_{0, 1}) |
| 1100 | (is in L_{1, 0}) |
| 1 | (is in L_{0, 0}) |
| 0011 | (is in L_{0, 1}) |
| 10100 | (is in L_{1, 0}) |
| 001011 | (is in L_{0, 1}) |
| 0 | (is in L_{1, 1}) |

In this case the bit strings 1, 0011, 100, 1, 011, 0, 0, 1011, 100, 011, 1100, 1, 0011, 10100, 001011, 0 appearing on the output line driver (5) will be linked together to give the bit string 100111001011001011100011110010011101000010110, which is a random encrypted message for the message 0100111101001011.

Decryption

Let us consider the bit string 100111001011001011100011110010011101000010110 as an encrypted message and suppose that the device is in decryption mode, so the decryption software is stored in the program memory (9). Also suppose that this is the message the device will decrypt in decryption mode.

For the values 1,0,0,1,1,1,0,0,1,0,1,1,0,0,1,0,1,1,1,0,0,0,1,1,1,1,0,0,1,0,0,1,1,1,0,1,0,0,0,0, 1,0,1,1,0 of the bit string 100111001011001011100011110010011101000010110 arriving bit by bit at the input at the input line driver (1) it will provide a suitable bit string for output line driver (5). Reading in the encrypted message bit by bit the device checks what state sequence the device goes through starting from its initial state (i.e. from state 0) due to the incoming bits as input signals. The final states (states 0 or 1) occurring during the checking process are written to the output line driver (5). (The occurrence of states 2, 3, 4 are not considered.) These values will correspondingly be 0,1,0,0,1,1,1,1,0,1,0,0,1,0,1,1. Linking these binary signals we get the bit string 0100111101001011, which is exactly the decrypted plaintext. Converting this bit string into hexadecimal form we get the hexadecimal character string 4F4B, which considered as an ASCII code we get the word OK.

Number of Key-automata

It is a subject of further research to give a better estimate for the number of key automata with a given number of input signals and a given number of states, and to find methods which can choose random elements from a wider class of key automata. We shall see that using the method described (which uses a relatively limited class of key automata for choosing randomly element) the number of key automata to choose from is huge.

Suppose, for simplicity, that the character set of the original message coincides with the input set {0, . . . , m−1} of the key automaton, and let {0, . . . , n−1} be the set of states, where m is at least 2 and n is at least two times m. Let 0 be the initial state and assign the state k as the final state to each element k in the character set of the original message. (It is not a problem that the initial state is a final state as well.) Let us create the transition matrix of the automaton as follows:

Step 1: for every k in the set {0, 1, . . . , m−1} let us give a random integer u between 0 and m−1, and an integer v between m and n−1, and write v in the u-th row and k-th column of the matrix (numbering of the rows and columns begins with 0);

Step 2: for every k in {m, . . . , 2m−1} give a random integer u between 0 and m−1 and write (k−m) into the u-th row and k-th column of the matrix;

Step 3: for each element k in {m, . . . , n−2)} give a random integer u between 0 and m−1 and write (k+1) into the u-th row and k-th column of the matrix;

Step 4: give a random integer u between 0 and m−1 and write m into the u-th row and (n−1)-st column of the matrix;

Step 5: choose a random number between 0 and n−1 for the other elements of the matrix.

By Step 1. there is a state j in {m, . . . , n−1} and an input signal for every state i in {0, 1, . . . , m−1} that takes the automaton from state i into state j. By Step 2., there is a state i in {0, 1, . . . , m−1} and an input signal for every state j in {m, m+1, . . . , 2m−1} which takes the automaton from state j into state i.

By steps 3. and 4. a suitable input signal will take the automaton from any state in {m, . . . , n−2} into the subsequent state, and a suitable signal will take it from state n−1 into state m. Thus for any state pair i,j in {m, . . . , n−1} there can be found arbitrarily many input signal strings that take the automaton from state i into state j, so that none of the intermediate states is in {0, 1, . . . , m−1}.

By Step 1., for each state i in {0, 1, . . . , m−1} there is a state j in {m, . . . , n−1} and an input signal which take the automaton from state i into state j. By Step 2., for each state j in {m, m+1, . . . , 2m−1} there is a state i in {0, . . . , m−1} and an input signal that take the automaton from state j into state i. Then by Steps 3. and 4. for every state pair i,j in {0, 1, . . . , m−1} there can be found any number of input signal strings, which take the automaton from state i into state j, so that none of the intermediate states is in {0, 1, . . . , m−1}. Since 0 is not the initial state alone, but the final state assigned to the input signal 0 as well, it means that the automaton generated is a key automaton indeed.

Suppose first, that m=2. Then before Step 5. there are n−2 empty entries in the matrix. Each of these entries can filled in n different ways in Step 5., which gives us nⁿ⁻² possibilities. Furthermore it is obvious that if we change two elements in the columns of the transition matrix, we get another key automaton, which multiplies the number of possibilities by 2ⁿ. If n=256, say, then the number of all the possible key automata is 256²⁵⁴×2²⁵⁶, that is 2²²⁸⁸.

Let m now be greater than 2. It is obvious that before Step 5. there is at least one empty entry in each column of the transition matrix, and it is also easy to see that they can be filled in n ways. Then in Step 5. we have at least nⁿ ways to fill the rest of the entries in the matrix. So, if n=256 there are at least 256²⁵⁶, that is the number of possible key automata is more than 2²⁰⁴⁸.

Authentication, Identification, Changing Keys

Authentication and identification are very important issues in computer applications. The person or the device we want to communicate with could be in the other room or on an other continent; neither the usual visual nor the acoustic traces help us here. So the aim of this invention is also to prove the person's or device's identity, including digital signatures as well—to assure the authenticity and identity of the message. Attackers, of course, do not have access to the key automaton used for encryption and decryption. However if relatively short messages are also allowed, the attacker can send a message to the recipient, which by mere chance will be an encrypted message. So it is better if the original message also has a secret key for authentication and identification. So for the proposed invention a typical message to be encrypted should consist of the following parts:
a digital signature as a common key for authentication and identification
the message itself
and, to advance security, the key automaton to be used for encrypting and decrypting the next message.

The digital signature for authentication may be omitted if it is not needed. Furthermore, usually, there is no need for a new key automaton for each interaction. So the description of the next key automaton may not be included, or if it is there, it can be the same as the current automaton.

Advantages of the Invention

The encrypted message in the invented device can represent any number of various plaintext messages, which makes breaking attempts, no matter how sophisticated and powerful background they use, practically impossible; it can be used as often as needed without any further key sharing and due to the simplicity of the operations used it is fast and the micro-technological realization is also feasible.
1) Resistance to code breaking and interference. The resistance of this invention to code breaking and interference is also due to the difficulty of a ciphertext only attack or a known plaintext attack as well. The key automaton is chosen randomly from a large set of elements. The implementation can be a key automaton with 256 states and 128 input signals, where the character set of the message can be coincident with the input set of the key automaton. As we have seen, there are more than 256²⁵⁶ possible key automata to be randomly generated. So this gives more than 2²⁰⁴⁸ options for choosing the key automaton. It is obviously impossible to break such a system using brute force. Furthermore it is enough to have a one bit mistake either in the key or in the encrypted message to cook the message. (It is not the aim of the invention to treat bit loss or bit changes due to transfer problems. This problem can be solved with the well-known protocol family TCP/IP.)
2) Each plaintext can be associated with several ciphertexts. The security of this invention is also due to the property that with a given key every message can have several encrypted versions. Suppose, for instance that the key automaton has 256 states, it has 128 input signals and final states, and let the minimal block length of the encrypted message be 10. In this case for any state the expected value of the number of input signals that take this state into an intermediate state is 128. Then the expected value of the number of input signal strings that take this state into a final state so that none of the intermediate states is a final state is 128¹⁰. So the expected value of the number of encrypted character strings that can be associated with a character of the plaintext is above 2⁷⁰. In this case (taking a page of typed text to be of 3 kilobytes storage capacity) the expected value of the number of encrypted messages for one page of typed text is 3×2⁸⁰. This means that even if the attacker can identify a plaintext—ciphertext pair, this information cannot be used to identify another encryption of the same message.
3) One character corresponds to several encrypted character strings. Following the previous line of argumentation it is expected after every 3.8×10¹⁷ (which is more than 2⁵⁸) pages to have the same encrypted character string for a given character. (We note that during computer software simulation we used a minimal block length of 10 characters and a maximal block length of 65536 characters for the ciphertext which meant that the ciphertext was about 14 times as long as the plaintext.) So code breaking based on the study of the frequency of repetitions is not successful either.
4) The length of the ciphertext (in a statistical sense) depends on the length of the plaintext. However choosing longer minimal and maximal block lengths for shorter messages and shorter minimal and maximal block lengths for longer messages, hackers cannot estimate even the length of the message from the ciphertext, although there are no dummy characters used.
5) Fast processing. The simplicity of the key automaton allows for fast processing. Testing software simulations of this invention were implemented using a computer programme written in C++. The implementation was tested on a conventional computer of 1.1 GHz frequency (IBM X40). The test results show that for a big key automaton (265 input signals and 512 states) and with big block lengths (10 bytes minimum and 65536 maximum) 120 kb/s as encryption speed and 210 kb/s as decryption speed, relative to the length of the plaintext. Choosing suitable hardware devices (microcontrollers, smart cards etc.) in the technical realisation can considerably improve the processing speed.
6) Broadcasting applicability. Test results show that the invention is efficient in broadcasting applications where the encryption device of the transmitter is relatively fast (at least twice as fast) compared to the speed of the receiver's decryption device.

1-14. (canceled)

15. An apparatus for encrypting and decrypting information, which has an encryption and/or decryption unit with plaintext and ciphertext input and output and a further input with an encryption and/or decryption key automaton attached, wherein to each element of the character set of the plaintext there is one or more final states of the key automaton assigned and each final state is assigned to one and only one element of the character set for every state pair, whose first element is the initial state or a final state, its second element is any final state, there are several, preferably 2¹²⁸ or even more distinct input signal strings such that the second element of the state pair is the same as the last element of the state string which state string is assigned by the extended transition function to the pair consisting of the first element of the state pair and the given input string and none of the intermediate elements of the state string is a final state.

16. The cryptographic apparatus in claim 15, wherein the key automaton is a Rabin-Scott key automaton, a deterministic automaton, a non-deterministic automaton, a weighted automaton, a cellular automaton, a two-way automaton, an automata network, a linearly limited/bounded automaton, a stack automaton, a tree automaton, a Turing machine, a transducer or some combination of these.

17. The cryptographic apparatus in claim 15, wherein the input and output of the cryptographic apparatus is attached to the processing unit through a line driver.

18. The cryptographic apparatus in claim 15, wherein a further input of the processing unit has a two-way connection with a key-automaton and data memory through a data bus.

19. The cryptographic apparatus of claim 15, wherein there is a program memory attached to the program input of the processing unit with a two-way connection and a further input of the processing unit has a two-way connection with a random number source preferably with a random number generator.

20. The cryptographic apparatus of claim 15, wherein the processing unit is a microcontroller, preferably an ATMegal28.

21. The cryptographic apparatus of claim 15, wherein the key automaton is burnt into a 4 kilobyte flash memory integrated into a microcontroller ATMegal28; the program memory is 128 kilobyte PROM module type integrated into ATMegal28; the data memory is 4 kilobyte MCU SMT type integrated into ATMegal28; the random number generator is PROTEGO R300 SMT type; the line driver (1,5) is RS232 with PC type plugging.

22. The cryptographic apparatus of claim 15, wherein the character set of the plaintext and the ciphertext is fixed, preferably a binary signal string of length 1, 2, 4 or 8 bits, the states of the key-automaton are also fixed, preferably binary signal strings of length 8 or 9 bits, the initial state of the key automaton is of numerical value 0, which is at the same time the final state assigned to the character of numeric value 0, for each character the state which is assigned to it as a final state has the same numeric value as that of the character.

23. Cryptographic method executable with the apparatus of claim 15, for encrypting and decrypting information, wherein in encryption mode the apparatus reads in the plaintext character by character, generates a randomly chosen character string of length falling into a given, adjustable length interval for each character in the plaintext taking the key automaton from its state (from the initial state first) without any intermediate final state into a final state assigned to the read plaintext character and the ciphertext consists of these character strings linked together.

24. The cryptographic method of claim 23, wherein in decryption mode the apparatus reads in the ciphertext character by character taking the key automaton from its state (from the initial state first) into the state which is associated by the transition function with the state of the key automaton and the read ciphertext character, and decryption is accomplished by linking together the input characters associated with the occurring final states, which provides the message in its original form.

25. The cryptographic method of claim 23, wherein the encrypted message is sent to several recipients simultaneously when used in broadcasting.

26. The cryptographic method of claim 23, wherein the plaintext message may include a digital signature, as a prefix of the plaintext, as a common secret key for authentication and identification, the actual message, the description of a subsequent key automaton for the forthcoming messages, for the sake of increased security.

27. The cryptographic method of claim 26, wherein the description of the subsequent key automaton is the same as the current one.

28. The cryptographic method of claim 26, wherein the digital signature or the description of the subsequent key automaton or both are omitted.
